(19) United States
(12) Patent Application Publication
(10) Pub. No.: US 2026/0273798 A1
(43) Pub. Date: Sep. 17, 2026

(54) PROCESS FOR MIXING A FLUID MELTFLOW STREAM AND RECYCLE

(71) Applicant: Dow Global Technologies LLC, Midland, MI (US)

(72) Inventors: Mohamed Esseghir, Collegeville, PA (US); Saurav S. Sengupta, Collegeville, PA (US); Mohammad Arif Hossain, Lake Jackson, TX (US); Irfan Khan, Lake Jackson, TX (US); Andreas Imthurn, Freeport, TX (US); Michael J. Parker, Bristol, PA (US)

(21) Appl. No.: 19/471,167

(22) PCT Filed: Mar. 8, 2024
(86) PCT No.: PCT/US2024/019129

§ 371 Date: Sep. 30, 2025

Related U.S. Application Data
(60) Provisional application No. 63/494,558, filed on Apr. 6, 2023.

(51) Int. Cl. B29B 7/48; B01F 23/451; B01F 23/47; B01F 25/31; B01F 25/62; B01F 101/00; B29B 7/94

(52) U.S. Cl. CPC B29B 7/481; B01F 23/451; B01F 23/47; B01F 25/31; B01F 25/62; B29B 7/94; B01F 2101/2805

(57) ABSTRACT

The present disclosure provides a process comprising providing an apparatus including (A) a passageway for receiving a first flow stream (FFS1), the passageway having an inflow end and an opposing outflow end, (B) a gear pump assembly downstream of the passageway, (C) one or more conduits extending along opposing sides of the gear pump assembly, each conduit being in fluid communication with the outlet of the gear pump assembly and the passageway, (D) an injector in each conduit for adding a second fluid (F2) into each conduit. The process includes introducing the F2 from each respective outlet duct into the FFS1 at a location upstream of the inlet of the gear pump assembly, feeding the FFS1 and the F2 into the inlet of the gear pump assembly and mixing, in the gear chamber, the F2 with FFS1 to form a mixed fluid flowstream and discharging it.

### BACKGROUND

Extruders and static mixers are commonly used to combine, or otherwise mix, two or more viscous materials such as polymer melt streams. A polymer melt stream is generally highly viscous and the flow of the polymer melt stream in the process is typically laminar with no natural mixing mechanism. The highly viscous nature of polymer melt streams makes the addition and mixing of small amounts of low viscosity fluid products (additive) problematic. Although an extruder (either twin-screw or single screw), can be used to mix a lower viscosity liquid additive into a polymer melt stream, extruders are difficult to scale-up, and production costs increase rapidly when increased production capacity and increased extruder size is desired.

Employing a static mixer carries the disadvantage of increasing capital costs. A static mixer impedes flow and correspondingly poses the risk of introducing significant pressure drop into a polymer melt flow production process. Pressure drop resulting from addition of a static mixer into a flow process can lead to potential dead zones in the production flowstream. Dead zones can lead to long term degradation of the polymer melt stream flow process.

The art recognizes the need for alternative mixing processes for polymer melt streams that avoid extruders and/or static mixers.

### SUMMARY

The present disclosure provides a process. In an embodiment, the process includes providing an apparatus. The apparatus includes (A) a passageway having a sidewall with an interior for receiving a first flow stream (FFS1), the passageway having an inflow end and an opposing outflow end. The apparatus includes (B) a gear pump assembly comprising (i) a housing, (ii) a gear chamber in the housing, (iii) an inlet placing the passageway outflow end in fluid communication with the gear chamber, (iv) a plurality of intermeshing gears mounted for rotation in the gear chamber, the gears having teeth which engage with each other in the chamber, and (v) an outlet in fluid communication with the gear chamber. The apparatus includes (C) one or more conduits. The conduits extend along opposing sides of the gear pump assembly. Each conduit is in fluid communication with the outlet and the passageway. Each conduit has an outlet duct in fluid communication with the passageway. The apparatus includes (D) an injector in each conduit for adding a second fluid (F2) into each conduit. The process includes introducing the second fluid from each respective outlet duct into the FFS1 at a location upstream of the inlet, feeding the FFS1 and the second fluid into the inlet. The process includes mixing, in the gear chamber, the second fluid with FFS1 to form a mixed fluid flowstream (mFFS), and discharging the mFFS from the outlet.

### BRIEF DESCRIPTION OF THE DRAWINGS

FIG. 1 is a sectional view of an apparatus with a gear pump in accordance with an embodiment of the present disclosure.

FIG. 2 is an enlarged view of Area 2 of FIG. 1.

FIG. 2A is an enlarged view of Area 2A of FIG. 2.

FIG. 3 is a sectional view showing flow and mixing profiles for the present apparatus.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be affected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

Ethylene-based polymer (interchangeably referred to as polyethylene) is a polymer comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low-Density Polyethylene (LLDPE); Ultra Low-Density Polyethylene (ULDPE); single-site catalyzed, Linear Low-Density Polyethylene, including both linear and substantially linear low-density resins (m-LLDPE); ethylene-based plastomers (POP) and ethylene-based elastomers (POE); Medium Density Polyethylene (MDPE); and High-Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and typically have a molecular weight distribution (“MWD”) greater than 2.5.

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers. Polyethylene (ethylene-based) elastomers plastomers generally have densities of 0.855 to 0.912 g/cm³.

An “olefin” is an unsaturated, aliphatic hydrocarbon having a carbon-carbon double bond.

An “olefin-based polymer” (interchangeably referred to as “polyolefin”) is a polymer that contains a majority weight percent of polymerized olefin monomer (based on the total amount of polymerizable monomers), and optionally, may contain at least one comonomer. Nonlimiting examples of olefin-based polymer include ethylene-based polymer and propylene-based polymer

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” (interchangeably referred to as “polypropylene”) is a polymer that contains more than 50 mole percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers). The terms “propylene-based polymer” and “polypropylene” may be used interchangeably. A nonlimiting example of a propylene-based polymer (polypropylene) is a propylene/α-olefin copolymer with at least one C₂ or C₄-C₁₀ α-olefin comonomer.

### Test Methods

Degree of mixing. The degree of mixing is quantified by the coefficient of variance (CoV) of the local concentration of second fluid (F2) relative to the first flow stream (FFS1) on a certain cross-sectional plane. The CoV defined in Equation 1, is calculated on a cross-sectional plane normal to the average flow velocity, where C is the concentration at position r and time t and C is the mean concentration.

$$CoV = \frac{σ}{\overline{C}} \qquad Equation 1$$

$$\overline{C} = Mean Concentration = \frac{1}{n} {\sum }_{i = 1}^{n} {C}_{i} \qquad Equation 2$$

$$σ = Standard deviation = \frac{{\sum }_{i = 1}^{n} {( {C}_{i} - \overline{C} )}^{2}}{n - 1} \qquad Equation 3$$

wherein n is the sample size, which is the number of computational fluid dynamics fluid elements in the cross-sectional plane and Cᵢ is the concentration in the ith fluid element. In general, the lower the CoV value, the higher degree of mixing.

Density is measured in accordance with ASTM D792, Method B. The result is recorded in grams (g) per cubic centimeter (g/cc or g/cm³).

Density for fluid flowstream is measured in accordance with ASTM D 792. The result is recorded in grams (g) per cubic centimeter (g/cc or g/cm³).

Melt index (I₂ or MI) is measured in accordance with ASTM D-1238 at 190° C. at 2.16 kg. The values are reported in g/10 min, which corresponds to grams eluted per 10 minutes

“Viscosity” refers to the resistance of a fluid which is being deformed by either sheer stress or tensile stress. For purposes of this specification, viscosity is measured at 130° C. using a Brookfield viscometer as measured in accordance with ASTM D 445. Results are reported in centipoise, cP.

### DETAILED DESCRIPTION

The present disclosure provides a process. In an embodiment, the process includes providing an apparatus. The apparatus includes (A) a passageway having a sidewall with an interior for receiving a first flow stream (FFS1). The passageway has an opening at an inflow end and an opening at an opposing outflow end. The apparatus includes (B) a gear pump assembly. The gear pump assembly includes (i) a housing, (ii) a gear chamber in the housing, (iii) an inlet placing the passageway in fluid communication with the gear chamber, (iv) a plurality of intermeshing gears mounted for rotation in the gear chamber, the gears having teeth which engage with each other in the chamber, and (v) an outlet in fluid communication with the gear chamber. The apparatus includes (C) one or more conduits, each conduit in fluid communication with the outlet and the passageway, each conduit having an outlet duct in fluid communication with the passageway. The apparatus includes (D) an injector in each conduit for adding a second fluid (F2) into each conduit. The process includes introducing the second fluid from each respective outlet duct into the FFS1 at a location upstream of the inlet. The process includes feeding the FFS1 and the second fluid into the inlet, mixing, in the gear chamber, the second fluid with FFS1 to form a mixed fluid flowstream (mFFS) and discharging the mFFS from the outlet.

Description is hereby provided with particular reference to the accompanying drawings, which illustrate the features and operation of embodiments of the present disclosure, but which are not intended to limit scope. In the Figures (unless otherwise indicated), like numerals are used throughout to designate like elements of the apparatus.

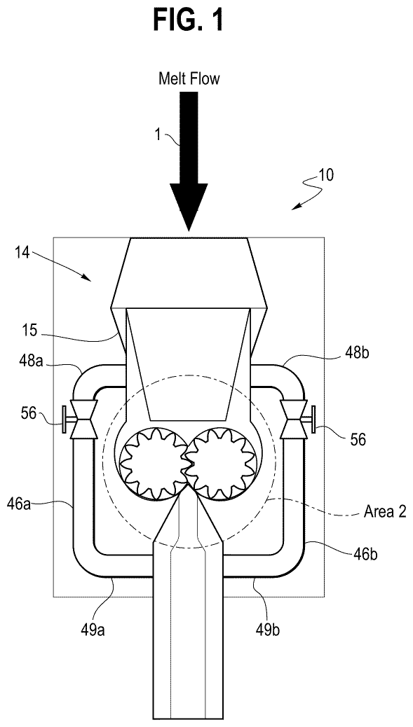

FIGS. 1-3 illustrate a mixing apparatus 10 having a gear pump 12, a passageway 14, and an outlet barrel 16. Passageway 14 has a sidewall 17, passageway 14 having a substantially uniform diameter, or a uniform diameter, along the length thereof. Sidewall 17 may or may not be an annular sidewall. Passageway 14 may or may not include a tapered section 15. When the tapered section is not present, passageway 14 has a substantially uniform diameter, or a uniform diameter, along the length of passageway 14.

Apparatus 10 includes a gear pump assembly. A “gear pump” is a positive displacement pump that moves a fluid (or one or more fluids) by repeatedly enclosing a fixed volume using intermeshing gears in a housing, the intermeshing gears transferring the fluid mechanically using a cyclic pumping action. The rotating gears develop a liquid seal with the pump housing and create suction at the pump inlet. Fluid drawn into the pump, is enclosed within the cavities of the rotating gears and the fluid is transferred to a discharge outlet.

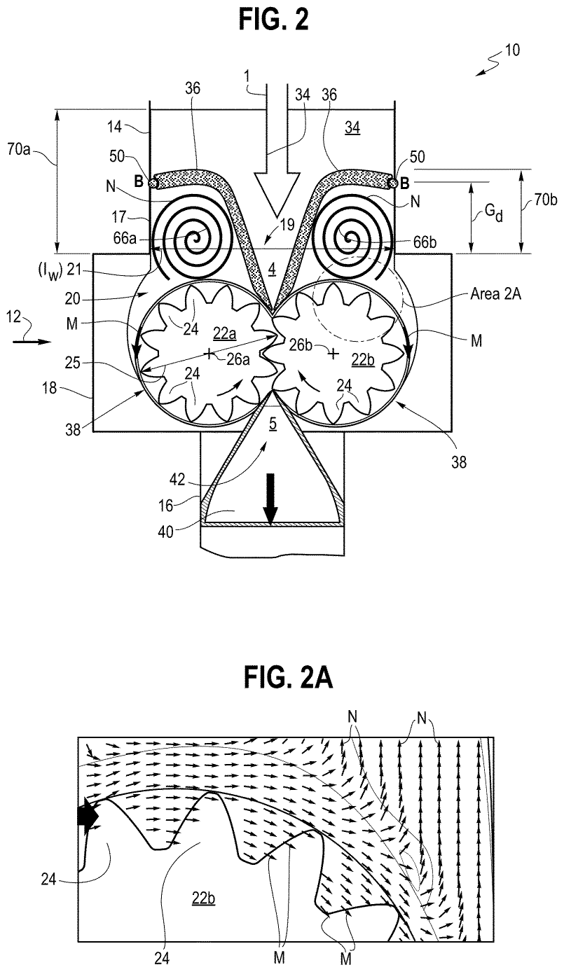

FIG. 2 is an enlarged view of Area 2 of FIG. 1. FIG. 2 shows gear pump assembly 12. Gear pump assembly 12 includes a housing 18 which defines a gear chamber 20. Gear chamber 20 has an inlet 19. Inlet 19 is an opening in housing 18 which places passageway 14 in fluid communication with gear chamber 20. Inlet 19 has an inlet width 21. Inlet width 21 is the longest length of inlet 19 that extends between opposing sides of housing 18. When the top-to-bottom length of inlet 19 is not the same length as the side-to-side length for inlet 19, inlet width 21 is the length that is the larger of the top-to-bottom length or the side-to-side length. When inlet 19 has a circular cross-sectional shape, inlet width 21 is the diameter of inlet 19. As the configuration and shape of inlet 19 may vary, the length of inlet width 21 may vary correspondingly. In other words, inlet width 21 may or may not include the aggregate of the diameters for intermeshed gears 22a and, 22b, in addition to the small clearance, or small gap, between each gear an inner wall of gear chamber 20. The length, or extent, of inlet width 21 is interchangeably referred to as “I_{w}.”

Within gear chamber 20 resides a plurality of (or two) intermeshing gears (interchangeably referred as gears, or gear (singular)), gear 22a and gear 22b. Each gear 22a, 22b has teeth 24. The teeth 24 of gear 22a intermesh with (or interlock with) the teeth 24 of gear 22b. In an embodiment, gear 22a is the same size and the same shape as gear 22b such that gear 22a and gear 22b each have a gear diameter 25, that is the same length. The “gear diameter,” as used herein, is the length of a straight line segment that begins from one gear tooth, passes through the axis of rotation, and extends across the gear to an opposing gear tooth, as shown by gear diameter 25, gear diameter 25 being a straight line segment shown in FIG. 2. Gear diameter 25 is interchangeably referred to as “G_{d}.” The term “gear diameter” is interchangeably referred to as “gear outer diameter” and/or “pitch diameter.” Alternatively, gear 22a may have a size and/or a shape that is different than the size and shape of gear 22b. Each gear 22a, 22b is supported by a separated shaft (not shown). Generally, one gear is driven by a motor and this drives the other gear (the idler). In an embodiment, both shafts may be driven by motors. The shafts are supported by bearings on each side of the casing. Each shaft rotates a respective gear about an axis of rotation. Gear 22a rotates about axis of rotation 26a, gear 22b rotates about axis of rotation 26b. As each gear 22a, 22b rotates about its respective axis of rotation, teeth 24 mate, intermesh, engage, or otherwise interengage with each other. As rotation of the gears continues the teeth disengage from each other.

In an embodiment, each gear has a helix angle. A “helix angle,” as used herein, is the angle between the axis of rotation of the gear and a line tangent to one of the teeth, from an an elevational view of the gear. The helix angle can be from 0° to 45°. In a further embodiment, the helix angle for the gears 22a, 22b is from 0° to 5°.

The process includes feeding a first fluid flowstream 34 into passageway 14. Passageway 14 has an upstream or inflow end for receiving the first fluid flowstream. Passageway 14 has a downstream, or outflow, end in fluid communication with inlet 19. A “fluid flowstream,” as used herein, is a material that is in a fluid state and moves, or otherwise flows, as a stream. Fluid flow is distinct from fine solid particle flow (pouring of sand, for example) because the fine solid particles (sand particles) are not in a fluid state. Flow is typically induced and sustained by gravity, but other forms of energy or force can be used to induce flow, e.g., that resulting from the use of a pump. Nonlimiting examples of first fluid flowstream (interchangeably referred to as “FFS1”) material include polymer in a melted, molten or otherwise flowable state including, polyester, polyamide, polyurethane, polyolefin (polyethylene, polypropylene), poly(ethylene terephthalate), natural rubber, synthetic rubber, EPDM, and combinations thereof. In an embodiment, the FFS1 has a viscosity from 0.1 g/10 min to 1000 g/10 min, or from 0.1 g/10 min to 100 g/10 min, or from 0.1 g/10 min to 10 g/10 min.

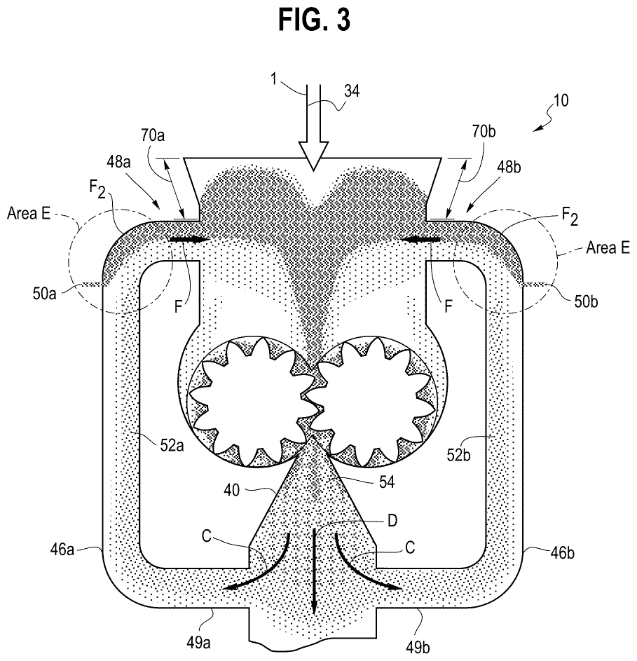

Apparatus 10 includes (C) one or more conduits. Each conduit is in fluid communication with (i) gear pump outlet 42 (interchangeably referred to as outlet 42) and/or outlet barrel 16 and (ii) with passageway 14. In an embodiment, apparatus 10 includes two conduits 46a, 46b, the conduits located on opposing sides of gear pump assembly 12, as shown in FIGS. 1 and 3. Each conduit 46a, 46b has a respective outlet duct 48a, 48b in fluid communication with passageway 14.

Apparatus 10 includes (D) injectors 50a, 50b in each respective conduit for adding a second fluid (F2) into each conduit. Although FIGS. 1 and 3 show a single injector in each conduit, it is understood that apparatus 10 may include one or more injectors for introducing a second fluid into FFS1. Apparatus 10 may include one, or two, or three, or four, or five, or six, or more injectors.

Each injector 50a, 50b is located in respective conduit 46a, 46b with each conduit outlet duct 48a, 48b located upstream of gear pump assembly 12. Injectors 50a, 50b are in fluid communication with a source for the second fluid, along with tubing, valve(s), and pump(s) for supplying the second fluid to the injectors. Nonlimiting examples of suitable materials for the second fluid (interchangeably referred to as “F2”) include colorant, a pigment, a carbon black, crosslinking agent, free radical initiator (peroxide) a glass fiber, an impact modifier, an antioxidant, a surface lubricant, a UV light absorbing agent, a metal deactivator, filler, a nucleating agent, a stabilizer, a flame retardant, and combinations thereof. It is understood F2 is a fluid and may or may not include solid particles dispersed therein, F2 having a viscosity less than the viscosity of FF1. In an embodiment, the second fluid has a viscosity that is less than the viscosity of the FFS1 In a further embodiment, the second fluid has a viscosity from 1 centiPoise (cP) to 5000 cP, or from 1 cP to 1000 cP, or from 1 cP to 100 cP, or from 1 cP to 10 cP.

In an embodiment, each injector 50a, 50b includes a set of a plurality of spaced-part ports extending along a portion of each respective conduit. Ports are bored through the wall of each conduit, the ports being in fluid communication with the source for the second fluid. The ports discharge, or otherwise dispense, the second fluid, along the length of each conduit and through the conduit wall. In an embodiment, the ports discharge a continuous flow of the second fluid through the conduit wall and along a length of each respective conduit 46a, 46b forming a fluidsheet in each conduit. A “fluidsheet,” as used herein, is a substantially continuous, or a continuous, fluid body composed of the second fluid disposed in the FFS1, the body of the fluidsheet having a length, a width, and a height when the FFS1 is viewed from a cross sectional view each outlet duct.

In an embodiment, each outlet duct 48a, 48b is located at a distance that is at least at least one-half of a gear diameter (or 0.5G_{d}) upstream of inlet 19. By way of example when gear 22a (and/or gear 22b) has a diameter of 32 cm, the distance of one-half gear diameter (or 0.5 G_{d}) is 16 cm. The process includes introducing second fluid 36 (interchangeably referred to as “F2”) into FFS1 34 at a distance that is at least one-half of a gear diameter, or 0.5G_{d}, upstream from inlet 19, or from 1 G_{d} to 5 G_{d}, or from 1 G_{d} to 3 G_{d}, or from 1.5 G_{d} to 3 G_{d} upstream of inlet 19. In an embodiment, apparatus 10 includes two injectors, first injector 50a and second injector 50b, injector 50a spaced apart from injection 50b along a passageway diameter 56, each injector 50a, 50b (and passageway diameter 56) located a distance at least 0.5G_{d} upstream from inlet 19 as shown in FIG. 2.

In an embodiment, each outlet duct 48a, 48b is located a distance that is at least the inlet width, I_{w}, upstream of inlet 19. In FIG. 2, location B indicates where outlet ducts 48a, 48b introduce the second fluid into passageway 14. The process includes introducing second fluid 36 (interchangeably referred to as “F2”) into FFS1 34 at a distance that is at least 1 I_{w}, upstream from inlet 19, or from 1 I_{w} to 5 I_{w}, or from 1 I_{w} to 3 I_{w}, or from 1.5 I_{w} to 3 I_{w} upstream of inlet 19.

In an embodiment, the process includes introducing the second fluid 36 (interchangeably referred to as “F2”) through each respective outlet duct 48a, 48b and into the FFS1 at a location at least 1 I_{w} upstream of inlet 19.

The process includes feeding the FFS1 and F2 into inlet 19 and mixing the F2 36 into the FFS1 34 in gear chamber 20. FFS1 34 and F2 36 enter gear chamber 20 from passageway 14. The counter-rotating gears 22a, 22b create a suction force at Area 4 (shown in FIG. 2) entrapping, or otherwise drawing, FFS1 and F2 into gear chamber 20. As counter-rotation of gears 22a, 22b continues, FFS1 and F2 are stretched in a space 38 between teeth 24 and the inner wall of gear chamber 20 as shown by arrows M in FIG. 2. With further gear rotation, stretching continues and a squeezing force occurs in space 38, mixing F2 into FFS1. As teeth 24 from gear 22a engage (or re-engage) with teeth 24 from gear 22b at Area 5, the entrapped F2 that is mixed into FFS1 is expelled from gear chamber 20, out and through outlet 42 as a mixed fluid flowstream 40 (or “mFFS 40”). This “suction-stretch-squeeze-expel” cycle repeats as gears 22a, 22b continue counter-rotating, the suction force entrapping new quantities of FFS1 34 and F2 36 between intermeshing teeth and gear chamber inner wall, continuing the cycle.

The process includes discharging the mFFS 40 from the outlet 42. From gear pump outlet 42 mFFS 40 flows into outlet barrel 16 for further processing and/or handling.

Bounded by no particular theory, Applicant discovered introducing the second fluid through conduits 46a, 46b eliminates the need for conduits that extend through, and within, the passageway interior. Applicant further discovered that introduction of the second fluid into FFS1 at a distance that is at least 0.5 G_{d} (or at least one I_{w}) upstream of inlet 19 unexpectedly creates, or otherwise defines, a recirculation zone in passageway 14 (or alternatively in the tapered section). A “recirculation zone,” as used herein, is a volume portion in passageway 14 (or a volume portion in the tapered section) with a downstream end defined by a plane encompassing inlet 19 and an upstream end defined by a plane encompassing elongated conduits located at least 0.5 G_{d} (or a distance at least one I_{w}) away from, and upstream to, inlet 19; the rotation of gears 22a, 22b creating in the volume portion (i) a laminar flow stream of FFS1 and the second fluid and (ii) a vortex flow stream of FFS1 and the second fluid. The recirculation zones perform two actions: (1) the recirculation zone moves the incoming second fluid sheets (F2) to a low-pressure zone at an apex of the gear intermeshing zone; and (2) the recirculation zone enhances the mixing of the second fluid sheets (F2), as a portion of the second fluid F2 initially mixes in the recirculation zone and then enters gear chamber 20.

In an embodiment, the process includes forming a laminar flow stream through gear chamber 20. A “laminar flow stream,” as used herein, is a flow where small disturbances in the form of eddies or vortices do not have energy sufficient to sustain; any eddies or vortices dissipate instantaneously; laminar flow inapposite to turbulent flow. The laminar flow stream includes a portion of FFS1 and a portion of F2 flowing through and around intermeshing gears 22a and 22b as shown by arrows M in FIG. 2.

In an embodiment, the process also includes forming a vortex flow stream in the recirculation zone. A “vortex flow stream,” as used herein, is a flow stream in the recirculation zone where a portion of FFS1 and/or including a portion of F2 revolves around an axis to create a vortex. The recirculation zone (composed of FFS1 and F2) is located in the passageway, such that the downstream end of the recirculation zone borders with the top of the gear-teeth, the passageway sidewall borders another side and the recirculation zone upstream end is defined by the location of the injectors, the injectors being a distance at least 0.5 G_{d} (or at least 1 I_{w}) upstream from inlet 19. The upstream end of the recirculation zone remains open to the viscous flow of FFS1 and FFS2 as shown by arrow 1 in FIGS. 1 and 2. Gear-pump assembly 12 with two gears rotating in opposite direction to each other, creates two recirculation zones, with a separate and discrete vortex flow in each recirculation zone, each recirculation zone upstream of each respective gear 22a, 22b, as shown in FIG. 2 and in FIG. 3

Each conduit 46a, 46b includes a respective inlet duct 49a, 49b. Each inlet duct 49a, 49b is in fluid communication with gear pump outlet 42 and/or outlet barrel 16. As mFFS 40 is discharged from and flows out of outlet 42, each inlet duct 49a, 49b is configured to receive a fraction of mFFS 40 from outlet 42 and direct this mFFS-fraction into respective conduits 46a, 46b. Each inlet duct 49a, 49b draws a portion of mFFS 40 from outlet 42 and into its respective conduit 46a, 46b, as shown by arrows C in FIG. 3. A majority of the flow of mFFS 40 continues downstream through outlet barrel 16, as shown by arrow D in FIG. 3.

In an embodiment, the process includes receiving, from outlet 42 (and/or outlet barrel 16), a portion of mFFS 40 into each respective inlet duct 49a, 49b as a recycled mixed fluid flowstream 52a, 52b (or “r-mFFS”) and adding, in each respective conduit 46a, 46b, the second fluid F2 to each respective r-mFFS 52a, 52b, vis-à-vis injectors 50a, 50b as shown at Area E in FIG. 3. The process includes introducing each respective r-mFFS 52a, 52b and F2 through respective outlet ducts 48a, 48b into passageway 14, as shown by arrows F in FIG. 3. The process includes mixing, in the gear chamber, the r-mFFS 52a, 52b with the FFS1 and the second fluid F2, and forming a composite mixed FFS 54 composed of (i) mFFS 40 and (ii) r-mFFS 52a, 52b and (iii) F2. Composite mixed FFS 54 has a CoV from 0.001 to 0.8, or from 0.1 to 0.5. The process includes discharging the composite mixed FFS 54 from the outlet 42 (and/or from outlet barrel 16).

In an embodiment, the process includes introducing each respective r-mFFS 52a, 52b, the second fluid, and FFS1 into passageway 14 at a distance that is at least one I_{w} upstream of inlet 19, thereby introducing each respective r-mFFS 52a, 52b, the second fluid, and FFS1 into the recirculation zone. The recirculation zone moves each respective r-mFFS 52a, 52b, the second fluid, and FFS1 to a low-pressure zone at an apex of the gear intermeshing zone; and (2) the recirculation zone enhances the mixing of each respective r-mFFS 52a, 52b, the second fluid, and FFS1, as a portion of the second fluid F2 initially mixes in the recirculation zone and then enters gear chamber 20.

In an embodiment, each conduit 46a, 46b includes a respective flow control valve 56 for moving respective r-mFFS 52a, 52b from the inlet duct to the outlet duct, as shown in FIG. 1.

The present disclosure advantageously provides a process for mixing a second fluid (F2), such as an additive to a polymer melt stream (FFS1) without the use of extruders and static mixers. In an embodiment, the present process is accomplished by utilizing a liquid additive injector system that is placed in the conduit carrying polymer flow to the gear-pump. The present disclosure also provides specific gear profile to achieve effective mixing. The shear and mixing provided by the gear-pump is capitalized to achieve the desired mixing.

It is specifically intended that the present disclosure not be limited to the embodiments and illustrations contained herein but include modified forms of those embodiments including portions of the embodiments and combinations of elements of different embodiments as come within the scope of the following claims.

1. A process comprising:
providing an apparatus comprising
(A) a passageway having a sidewall with an interior for receiving a first flow stream (FFS1), the passageway having an inflow end and an opposing outflow end;
(B) a gear pump assembly comprising
(i) a housing,
(ii) a gear chamber in the housing,
(iii) an inlet placing the passageway outflow end in fluid communication with the gear chamber,
(iv) a plurality of intermeshing gears mounted for rotation in the gear chamber, the gears having teeth which engage with each other in the chamber, and
(v) an outlet in fluid communication with the gear chamber,
(C) one or more conduits, the conduits extending along opposing sides of the gear pump assembly, each conduit in fluid communication with the outlet and the passageway, each conduit having an outlet duct in fluid communication with the passageway, and
(D) an injector in each conduit for adding a second fluid (F2) into each conduit, the process comprising
introducing the second fluid from each respective outlet duct into the FFS1 at a location upstream of the inlet;
feeding the FFS1 and the second fluid into the inlet;
mixing, in the gear chamber, the second fluid with FFS1 to form a mixed fluid flowstream (mFFS); and
discharging the mFFS from the outlet.

2. The process of claim 1 wherein each conduit comprises an inlet duct in fluid communication with the outlet, the process comprising
receiving, from the outlet, a portion of the mFFS into each respective inlet duct as a recycled mixed fluid flowstream (r-mFFS); and
adding, in each respective conduit, the second fluid to each respective r-mFFS.

3. The process of claim 2 comprising
introducing the r-mFFS and the second fluid into the passageway;
mixing, in the gear chamber, the r-mFFS with the FFS1 and the second fluid;
forming a composite mixed FFS comprising (i) the mFFS and (ii) the r-mFFS; and
discharging the composite mixed FFS from the outlet.

4. The process of claim 1 wherein each gear has a gear diameter and the passageway comprises a recirculation zone defined by a passageway volume portion from the inlet and upstream a distance of at least one-half of a gear diameter, the process comprising
forming a vortex flow of the FFS1, F2, and the r-mFFS in the recirculation zone.

5. The process of claim 1 wherein each conduit comprises a plurality of ports spaced apart along a sidewall of each conduit, the process comprising
discharging the second fluid from the ports.

6. The process of claim 1 any of claims 1-5, wherein the inlet has a width (I_{w}), and the passageway comprises a tapered section having an upstream end with a diameter greater than I_{w} and reducing to a downstream end having a diameter that is less than or equal to I_{w}, the process comprising
positioning the outlet duct for each conduit at the upstream end of the tapered section;
introducing the second fluid from each respective conduit into the FFS1 at a location at least one inlet width (I_{w}) upstream of the inlet.

7. The process of claim 1 comprising forming a composite mixed FFS having a Coefficient of Variance from 0.001 to 0.8.
